(19) United States
(12) Patent Application Publication
(10) Pub. No.: US 2014/0225518 A1
(43) Pub. Date: Aug. 14, 2014

(54) SEMICONDUCTOR LIGHT SOURCE APPARATUS AND PROJECTION TYPE IMAGE DISPLAYING APPARATUS

(71) Applicant: Panasonic Corporation, Osaka (JP)

(72) Inventor: Takaaki GYOTEN, Hyogo (JP)

(73) Assignee: Panasonic Corporation, Osaka (JP)

(21) Appl. No.: 14/179,873

(22) Filed: Feb. 13, 2014

(30) Foreign Application Priority Data
Feb. 13, 2013 (JP) 2013-025188
Feb. 7, 2014 (JP) 2014-022506

(51) Int. Cl. H05B 33/08

(52) U.S. Cl. CPC H05B 33/0821
USPC 315/185 R

(57) ABSTRACT

A semiconductor light source apparatus includes a first light source circuit that includes one or more serially-connected semiconductor light source elements, a second light source circuit that includes one or more serially-connected semiconductor light source elements, the second light source circuit being serially connected to the first light source circuit via a connecting portion on a low-voltage side of the first light source circuit, a power source circuit configured to supply a power supply voltage to a series connection circuit including the first light source circuit and the second light source circuit, and a conductor to which the first light source circuit and the second light source circuit are mounted. The connecting portion is electrically connected and grounded to the conductor.

### BACKGROUND

1. Technical Field

The present disclosure relates to semiconductor light source apparatus which drives a plurality of serially-connected semiconductor light source elements, and a projection type image displaying apparatus using the semiconductor light source apparatus.

2. Related Art

JP 2011-258616 A discloses an LED driving circuit capable of driving a predetermined constant current without being affected by a change in power supply voltage, characteristics of LEDs (light-emitting diodes), and usage environment merely, by being provided with the power supply voltage equal to or larger than a driving voltage of the LEDs. The LED driving circuit includes a DC power source V and a constant current circuit connected between terminals of the DC power source V. An array of serially-connected LEDs is connected to the constant current circuit. At least one LED is connected between output terminals of the constant current circuit. The constant current circuit is connected to a floating ground. Such configuration enables the LED driving circuit to drive a predetermined constant current without being affected by a change in power supply voltage, characteristics of the LEDs, and usage environment.

### SUMMARY

The present disclosure provides a semiconductor light source apparatus that can lower a voltage applied between light emitting elements of the semiconductor light source and the case storing the light emitting elements, and increase the number of semiconductor light sources capable of being serially connected to be driven.

The semiconductor light source apparatus in the present disclosure includes a first light source circuit that includes one or more serially-connected semiconductor light source elements, a second light source circuit that includes one or more serially-connected semiconductor light source elements, the second light source circuit being serially connected to the first light source circuit via a connecting portion on a low-voltage side of the first light source circuit, a power source circuit configured to supply a power supply voltage to a series connection circuit including the first light source circuit and the second light source circuit, and a conductor to which the first light source circuit and the second light source circuit are mounted. The connecting portion is electrically connected and grounded to the conductor.

The semiconductor light source apparatus in the present disclosure can reduce the maximum value of the potential difference between the plurality of serially-connected semiconductor light source elements and the case storing the semiconductor light source elements, thereby increasing the number of the semiconductor light source elements that can be mounted in the semiconductor light source apparatus.

### BRIEF DESCRIPTION OF DRAWINGS

FIG. 1 is a block diagram of a semiconductor light source apparatus according to a first embodiment.

FIG. 2 is a sectional view showing the configuration of a main part of a semiconductor light source element used in the embodiment.

FIG. 3 is a view showing the state in which the semiconductor light source element used in the embodiment is mounted to a conductor.

FIG. 4 is a view showing the voltage relation between the serially-connected semiconductor light source elements.

FIG. 5 is a view for describing the voltage relation between the serially-connected semiconductor light source elements in the first embodiment.

FIG. 6 is a block diagram of a semiconductor light source apparatus according to a second embodiment.

FIG. 7 is a block diagram of a semiconductor light source apparatus according to a third embodiment.

FIG. 8 is a block diagram of a semiconductor light source apparatus according to a fourth embodiment.

FIG. 9 is a block diagram of a projection type image displaying apparatus according to a fifth embodiment.

### DETAILED DESCRIPTION OF PREFERRED EMBODIMENTS

Embodiments will be described in detail below by referring to the drawings as necessary. Note, however, that an unnecessarily detailed description may be omitted. For example, a detailed description of already well-known matters or an overlapping description of substantially the same configuration may be omitted. This is to avoid the following description from unnecessarily becoming redundant and facilitate understanding by those skilled in the art.

Note that the inventor provides the accompanying drawings and the following description in order for those skilled in the art to thoroughly understand the present disclosure, and thus, it is not intended that the subject matter described in the claims is limited thereby.

### First Embodiment

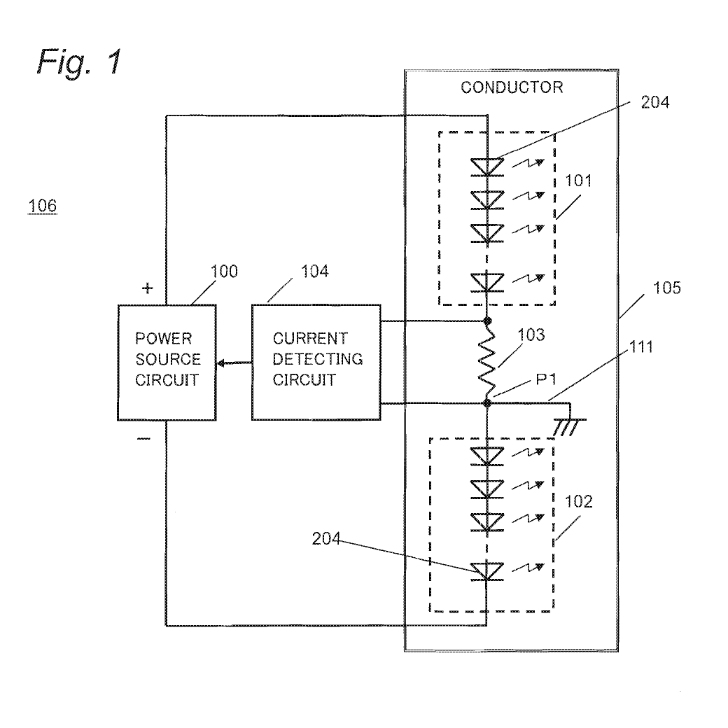

A first embodiment will be described below with reference to FIG. 1 to FIG. 5.

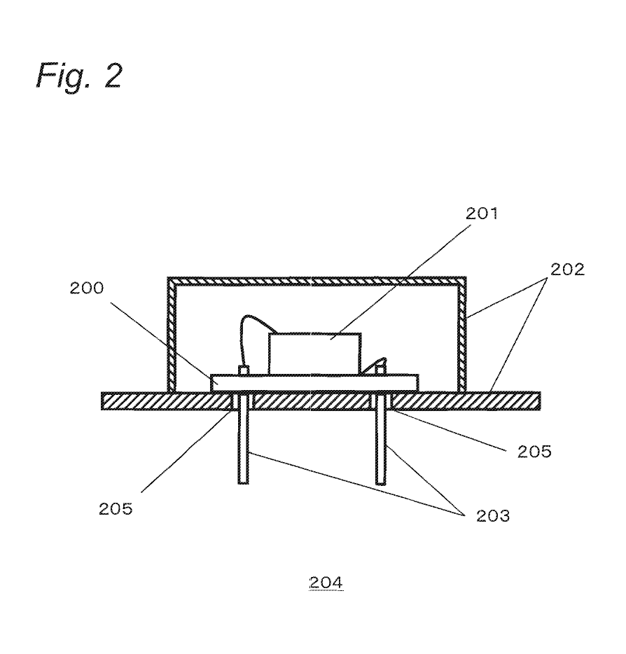

FIG. 1 is a block diagram of a semiconductor light source apparatus according to the first embodiment. FIG. 2 is a sectional view showing the configuration of a main part of a semiconductor light source element included in the semiconductor light source apparatus in the embodiment.

As shown in FIG. 1, the semiconductor light source apparatus 106 includes a power source circuit 100 for supplying power, a first light source circuit 101 having one or more serially-connected semiconductor light source elements 204, a second light source circuit 102 having one or more serially-connected semiconductor light source elements 204, and a current detecting circuit 104 for detecting a current flowing through the first and second light source circuits 101 and 102.

A resistor for detecting a current 103, which composes a connecting portion for serially connecting the first light source circuit 101 to the second light source circuit 102, is connected between the first light source circuit 101 and the second light source circuit 102.

The current detecting circuit 104 detects a current flowing through the resistor 103, that is, the first and second light source circuits 101 and 102 based on a voltage across the resistor 103, and outputs the detected current value to the power source circuit 100.

The power source circuit 100 is configured as a so-called floating power source. The power source circuit 100 controls the power supply voltage based on the output of the current detecting circuit 104 to keep the current flowing through the resistor 103 (that is, through the first and second light source circuits 101 and 102) constant. The first source circuit 101 is connected to a high voltage-side output terminal of the power source circuit 100. The second light source circuit 102 is connected to a low voltage-side output terminal of the power source circuit 100.

The semiconductor light source apparatus 106 in the present embodiment includes a conductor (conductor plate) 105 that is a metallic heat sink. The first light source circuit 101 and the second light source circuit 102 are mounted to the conductor 105, and a connection point P1 between the resistor 103 and the second light source circuit 102 is grounded to the conductor 105 via a conducting wire 111.

FIG. 2 is a sectional view showing the internal configuration of the semiconductor light source element 204, and the semiconductor light source element 204 includes a light emitting element 201, terminals 203 connected to the light emitting element 201, an insulating board 200 provided in contact with the light emitting element 201 and the terminals 203, and a conductive case 202 in contact with the insulating board 200. The terminals 203 protrude outside the case 202 through respective through holes 205 provided in the conductive case 202. The terminals 203 are not in contact with the case 202 and are electrically insulated from the case 202.

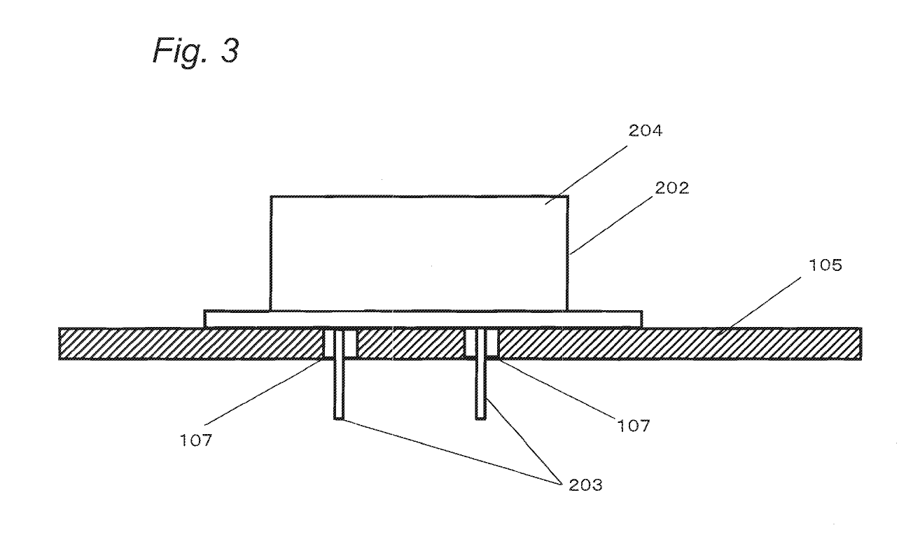

The semiconductor light source element 204 is mounted to the conductor 105 that is a metallic heat sink as shown in FIG. 3. The terminals 203 are disposed through respective through holes 107 of the conductor 105, and the case 202 is in contact with the conductor 105.

The terminals 203 are not in contact with the conductor 105, and are electrically insulated from the conductor 105. In contrast, the case 202 is electrically connected to the conductor 105.

The operation of the semiconductor light source apparatus 106 thus configured will be described below.

As described above, the semiconductor light source elements 204 includes the light emitting element 201, the terminals 203 connected to the light emitting element 201, the insulating board. 200 provided in contact with the light emitting element 201 and the terminals 203, and the case 202 in contact with the insulating board. 200.

With such configuration, the light emitting element 201 is insulated from the case 202, and heat of the light emitting element 201 can be radiated from the case 202 through the insulating board 200.

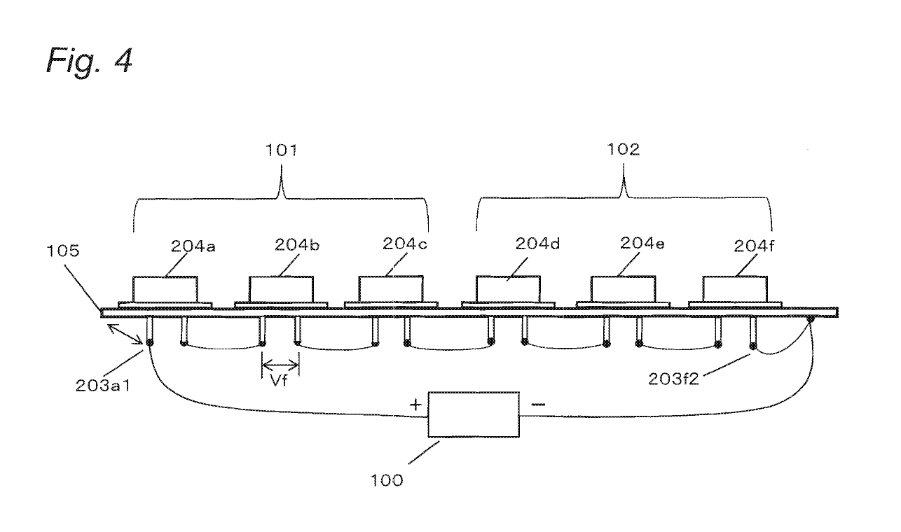

FIG. 4 is a view showing the state in which the semiconductor light source elements 204 are mounted to the conductor 105 according to the conventional art to describe an object of the present embodiment.

In the present example, three serially-connected semiconductor light source elements 204a, 204b, and 204c as the first light source circuit 101 and three serially-connected semiconductor light source elements 204d, 204e, and 204f as the second light source circuit 102 are mounted to the conductor 105. A terminal 203f2 of the semiconductor light source element 204f located in the last stage of the second light source circuit 102, is connected to the conductor 105, the terminal 203f2 being not connected to the semiconductor light source element 204e.

It is assumed that, in this state, a voltage is supplied from the power source circuit 100 to a terminal 203a1 out of the terminals of the semiconductor light source element 204a in the first light source circuit 101, and the conductor 105 to activate the light emitting element 201, the terminal 203a1 being not connected to the adjacent semiconductor light source element 204b.

A voltage between the terminals of each of the semiconductor light source elements 204a to 204f in the first light source circuit 101 and the second light source circuit 102 is an operating voltage Vf of the light emitting element.

Accordingly, in the configuration shown in FIG. 4, a maximum voltage between the terminals of the semiconductor light source elements 204a to 204f and the case 202 or the conductor 105 is 6Vf that is six times as large as the operating voltage Vf of the light emitting element 201. The maximum voltage can occur between the terminal 203a1 of the semiconductor light source elements 204a and the case 202 of the semiconductor light source elements 204a or the conductor 105.

That is, with the configuration in FIG. 4, when N semiconductor light source elements 204 are mounted on the conductor 105, a voltage Vmax between the terminal of the semiconductor light source element to which the highest voltage is applied and the case of the semiconductor light source or the conductor is as follows:

Vmax=Vf×N

An allowable potential difference between the terminals 203 of the semiconductor light source elements 204 and the case 202 or the conductor 105 has an upper limit (withstand voltage). The upper limit of the allowable potential difference limits the number of semiconductor light source elements 204 that can be mounted on the conductor 105. That is, the number of the mountable semiconductor light source elements 204 needs to be determined so that the number of the semiconductor light source elements mounted on the conductor 105 x the operating voltage Vf of the light emitting element 201 does not exceed the upper limit (withstand voltage) of the allowable potential difference.

In the present embodiment, to mount more semiconductor light source elements 204 on the conductor 105, the semiconductor light source elements 204 are mounted in the semiconductor light source apparatus 106 as shown in FIG. 1. That is, in the semiconductor light source apparatus 106, the first light source circuit 101 having the plurality of serially-connected semiconductor light source elements 204 is connected to the second light source circuit 102 having the plurality of serially-connected semiconductor light source elements 204 via the resistor 103. Also, the first light source circuit 101 and the second light source circuit 102 are mounted to the conductor 105. Further, the connecting point P1 between the resistor 103 and the second light source circuit 102 is grounded to the conductor 105 via the conductor 111.

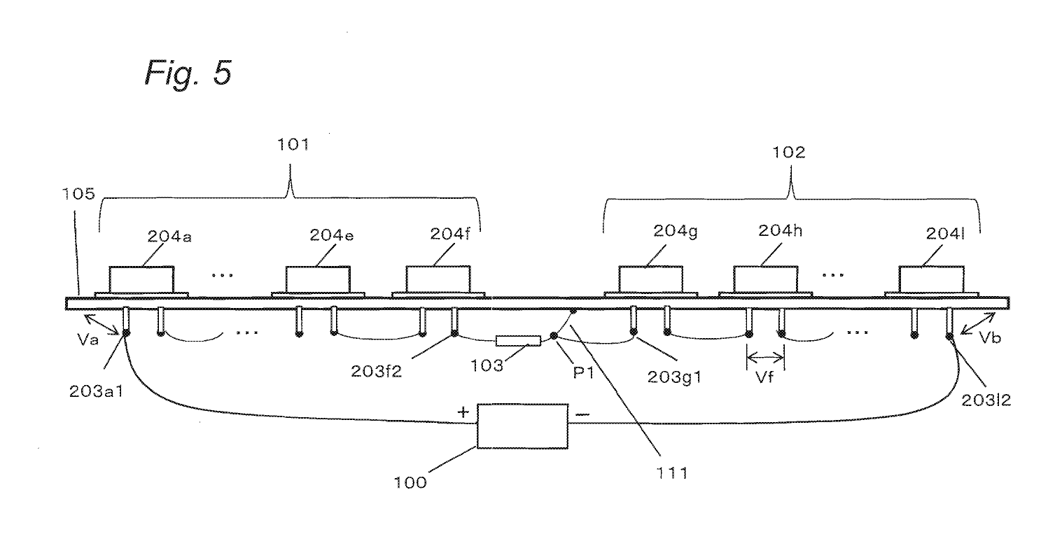

FIG. 5 is a view for describing the state in which the semiconductor light source elements 204 are connected to the conductor 105 in the semiconductor light source apparatus 106 according to the present embodiment more specifically.

The six serially-connected semiconductor light source elements 204a to 204f as the first light source circuit 101 and the six serially-connected semiconductor light source elements 204g to 204l as the second light source circuit 102 are mounted to the conductor 105. One end of the resistor 103 is connected to the terminal 203f2 of the semiconductor light source element 204f in the last stage of the first light source circuit 101, the terminal 203f2 being not connected to the semiconductor light source element 204e. The other end of the resistor 103 is connected and grounded to the conductor 105 at the connection point P1 via the conductor 111. The other end of the resistor 103 is also connected to the terminal 203g1 of the semiconductor light source element 204g in the initial stage of the second light source circuit 102.

Through such connecting portion, when a voltage across the resistor 103 is defined as Vr, a voltage Va between the terminal 203a1 of the semiconductor light source element 204a to which the highest voltage is applied in the first light source circuit 101 and the case 202 or the conductor 105 is, since the number of the semiconductor light source elements 204 mounted in the first light source circuit 101 is six, as follows:

Va=6Vf+Vr

Further, since the number of the semiconductor light source elements 204 mounted in the second light source circuit 102 is six, a voltage Vb between the terminal 203l2 of the semiconductor light source element 204l to which the highest voltage is applied in the second light source circuit 102 and the case 202 or the conductor 105 is as follows:

Vb=6Vf

The resistance value of the resistor 103 is generally set so that the voltage Vr across the resistor 103 is a low voltage which is not higher than about 2V (volt).

As described above, in the present embodiment, since the connecting portion between the first light source circuit 101 and the second light source circuit 102 is grounded, the semiconductor light source elements 204 may be implemented so that the maximum potential differences Va and Vb between the terminals of the semiconductor light source elements 204 and the case 202 or the conductor 105 in the first light source circuit 101 and the second light source circuit 102, respectively, is lower than the upper limit of the allowable potential difference. Accordingly, in each of the first light source circuit 101 and the second light source circuit 102, the maximum number of the semiconductor light source elements 204 can be mounted, the maximum number being determined by the allowable potential difference. Thus, when the same number of the semiconductor light source elements 204 are mounted in each of the first light source circuit 101 and the second light source circuit 102, the number of the semiconductor light source elements 204 can be substantially doubled as compared to the conventional configuration (refer to FIG. 4).

Assuming that the upper limit of the allowable potential difference is about 6Vf, with the configuration in FIG. 4, the six semiconductor light source elements 204 in total can be mounted in the first and second light source circuits 101 and 102. In contrast, with the configuration in FIG. 5 (FIG. 1), the six semiconductor light source elements 204 can be mounted in each of the first and second light source circuits 101 and 102, that is, the 12 semiconductor light source elements 204 in total can be mounted. In other words, about twice as many as the semiconductor light source elements 204 in the configuration in FIG. 4 can be mounted.

Returning to FIG. 1, the current detecting circuit 104 detects the voltage across the resistor 103, thereby detecting the current flowing through the resistor 103, that is, the first light source circuit 101 and the second light source circuit 102. The power source circuit 100 controls the voltage outputted to the first light source circuit 101 and the second light source circuit 102 based on the current value detected by the current detecting circuit 104. Since the forward voltage Vf caused by the semiconductor light source elements 204 changes due to heat generation, the current flowing through the resistor 103, that is, the first light source circuit 101 and the second light source circuit 102 changes. Accordingly, the power source circuit 100 controls the output voltage based on the current value detected by the current detecting circuit 104 to lead an intended current to the first light source circuit 101 and the second light source circuit 102.

As described above, the semiconductor light source apparatus 106 in the present embodiment includes the first light source circuit 101 having the one or more serially-connected semiconductor light source elements 204, the second light source circuit 102 that has the one or more serially-connected semiconductor light source elements 204 and is serially connected to the first light source circuit 101 through the connecting portion (P1) on the low-voltage side of the first light source circuit, the power source circuit 100 supplying the power supply voltage to the series circuit composed of the first light source circuit 101 and the second light source circuit 102, and the conductor 105 to which the first light source circuit 101 and the second light source circuit 102 are mounted. The connecting portion (P1) is electrically connected and grounded to the conductor 105.

With this configuration, about twice as many as the semiconductor light source elements 204 limited by the allowable potential difference between the terminals 203 of the semiconductor light source elements 204 and the case 202 can be mounted.

Further, the current detecting circuit 104 detects the voltage across the resistor 103, thereby detecting the current flowing through the resistor 103, that is, the current flowing through the first light source circuit 101 and the second light source circuit 102 to control the power source circuit 100. With such configuration, one side of the resistor 103 is put into the GND (ground) level, and the voltage across the resistor 103 is generally small. Thus, there is an advantage that when the current detecting circuit 104 operates based on the GND (ground) level, the voltage potential of the voltage for detecting the current by the current detecting circuit 104 is low.

### Second Embodiment

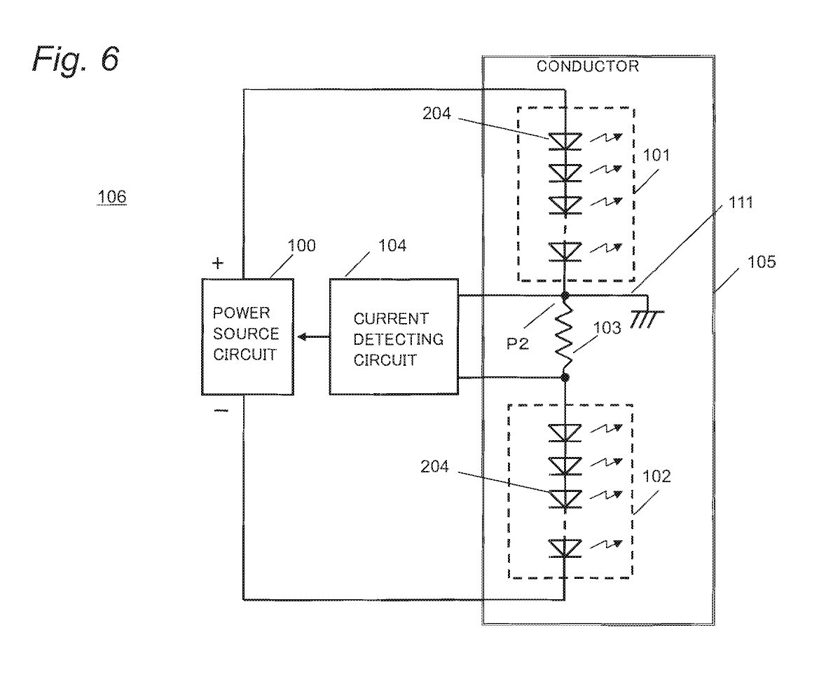

A second embodiment will be described below with reference to FIG. 6.

FIG. 6 is a block diagram of a semiconductor light source apparatus according to the second embodiment.

The same constituent elements in the second embodiment as those in the first embodiment are given the same reference numerals. In the first embodiment, the connecting portion between the resistor 103 and the second light source circuit 102 is grounded to the conductor 105. In contrast, in the second embodiment, a connecting portion (connection point P2) between the resistor 103 and the first light source circuit 101 is grounded to the conductor 105 via the conductor 111.

The operation of the semiconductor light source apparatus 106 in the second embodiment is the same as that of the semiconductor light source apparatus 106 in the first embodiment. A voltage of the terminal 203 of the semiconductor light source element 204 to which the highest voltage is applied in the first light source 101 with respect to the conductor 105 is the number of the semiconductor light source elements 204 mounted in the first light source circuit 101×Vf. A voltage of the terminal 203 of the semiconductor light source element 204 to which the highest voltage is applied in the second light source circuit 102 with respect to the conductor 105 is the number of the semiconductor light source elements 204 mounted in the second light source circuit 102×Vf+the voltage across the resistor 103. The resistance value of the resistor 103 is generally set so that the voltage Vr across the resistor 103 is a low voltage which is not higher than about 2V (volt) or lower.

As described above, in the semiconductor light source apparatus in the present embodiment, like the semiconductor light source apparatus 106 in the first embodiment, about twice as many as the semiconductor light source elements 204 in the conventional configuration (refer to FIG. 4) can be mounted.

Further, the current detecting circuit 104 detects the voltage across the resistor 103, thereby detecting the current flowing through the resistor 103, that is, the current flowing through the first light source circuit 101 and the second light source circuit 102 to control the power source circuit 100. With such configuration, one side of the resistor 103 is put into the GND (ground) level, and the voltage across the resistor 103 is generally small. Thus, there is an advantageous that when the current detecting circuit 104 operates based on the GND (ground) level, the voltage potential of the voltage for detecting the current by the current detecting circuit 104 is low.

### Third Embodiment

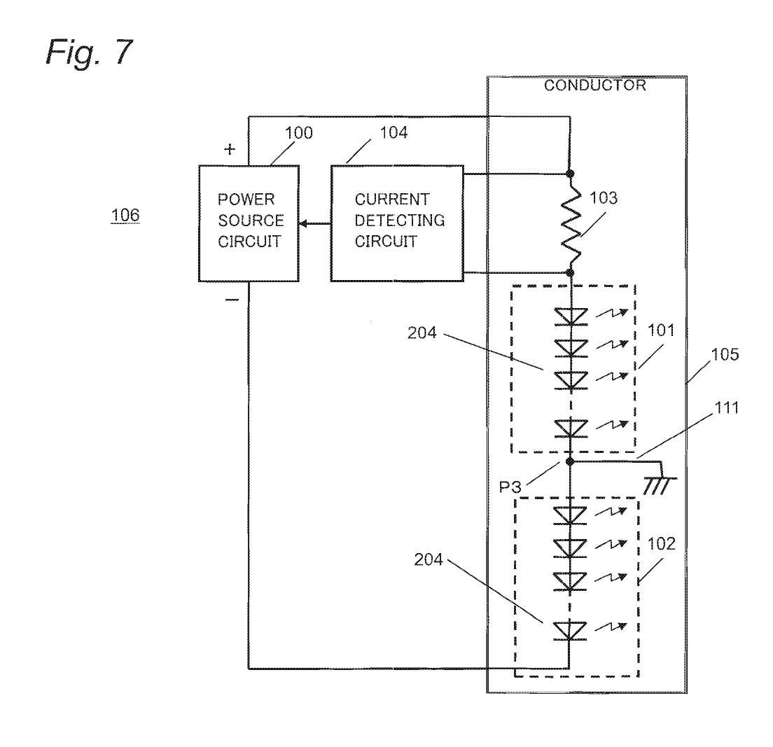

A third embodiment will be described below with reference to FIG. 7.

FIG. 7 is a block diagram of a semiconductor light source apparatus according to the third embodiment,

The same constituent elements in the third embodiment as those in the first embodiment are given the same reference numerals. In the first embodiment, the resistor 103 is connected between the first light source circuit 101 and the second light source circuit 102. In contrast, in the present embodiment, the resistor 103 is serially inserted between the power source circuit 100 and the first light source circuit 101, that is, is inserted on the high-voltage side of the first light source circuit 101. The first light source circuit 101 is also connected to the second light source circuit 102 at a connecting portion, and the connection point P3 is connected (grounded; to the conductor 105 via the conductor 111.

Also in the present embodiment, like the semiconductor light source apparatus 106 in the first embodiment, the voltage at the terminal of the semiconductor light source element 204 to which the highest voltage is applied in the second light source circuit 102 is the number of the semiconductor light source elements 204 mounted in the second light source circuit 102×Vf. Further, like the semiconductor light source apparatus 106 in the second embodiment, the voltage at the terminal of the semiconductor light source element 204 to which the highest voltage is applied in the first light source circuit 101 is the number of the semiconductor light source elements 204 mounted in first light source circuit 101×Vf.

As above, in the present embodiment, about twice as many as the semiconductor light source elements 204 in the conventional configuration (refer to FIG. 4) can be mounted.

Further, the current detecting circuit 104 detects the voltage across the resistor 103 serially connected between the power source circuit 100 and the first light source circuit 101, thereby detecting the current flowing through the resistor 103 to control the power source circuit 100. With such configuration, one side of the resistor 103 is put into the level on the plus side of the power source circuit 100, and the voltage across the resistor 103 is generally small. Thus, there is an advantageous that when the current detecting circuit 104 operates based on the plus side of the power source circuit 100, the voltage potential of the voltage for detecting the current by the current detecting circuit 104 is low.

### Fourth Embodiment

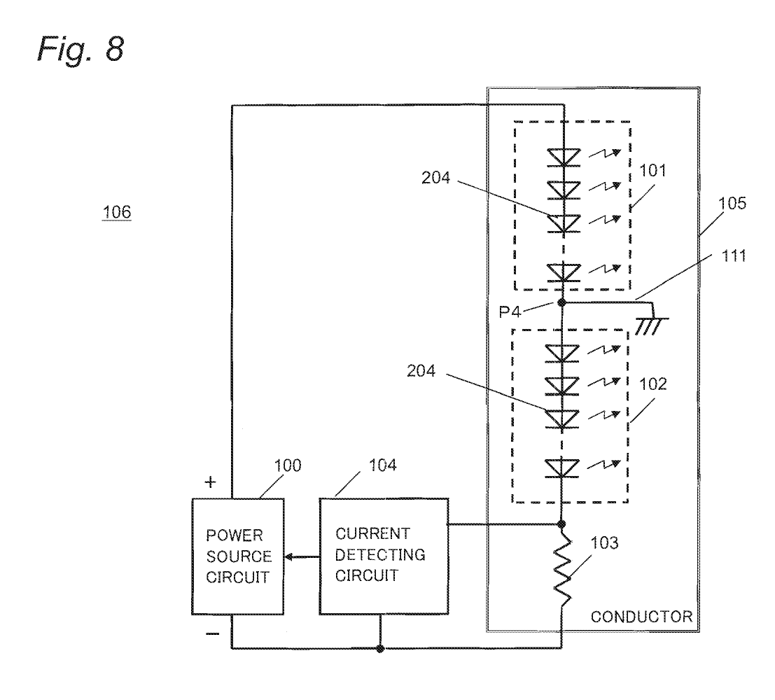

A fourth embodiment will be described below with reference to FIG. 8.

FIG. 8 is a block diagram of a semiconductor light source apparatus according to the fourth embodiment.

The same constituent elements in the present embodiment as those in the first embodiment are given the same reference numerals. In the first embodiment, the resistor 103 is inserted between the first light source circuit 101 and the second light source circuit 102. In contrast, in the present embodiment, the resistor 103 is serially inserted between the second light source circuit 102 and the power source circuit 100, that is, is inserted on the low-voltage side of the second light source circuit 102.

Further, the first light source circuit 101 is connected to the second light source circuit 102 at a connecting portion, and the connection point P4 is connected (grounded) to the conductor 105.

The operation of the semiconductor light source apparatus in the present embodiment is the same as that of the semiconductor light source apparatus in the third embodiment.

Also in the present embodiment, like the first embodiment, about twice as many as the semiconductor light source elements 204 in the conventional configuration (refer to FIG. 4) can be mounted.

Further, the current detecting circuit 104 detects the voltage across the resistor 103 serially connected between the second light source circuit 102 and the power source circuit 100, thereby detecting the current flowing through the resistor 103 to control the power source circuit 100. With such configuration, one side of the resistor 103 is put into the level on the minus side of the power source circuit 100, the voltage across the resistor 103 is generally small. Thus, there is an advantageous when the current detecting circuit 104 operates based on the minus side of the power source circuit 100, the voltage potential of the voltage for detecting the current by the current detecting circuit 104 is low.

### Fifth Embodiment

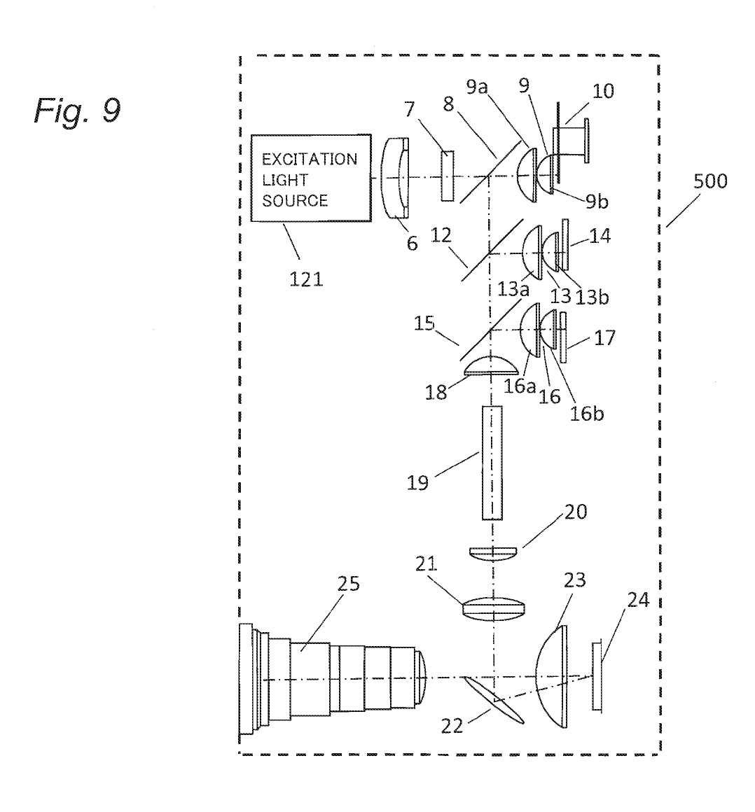

A projection type image displaying apparatus including the semiconductor light source apparatus 106 described in each above-mentioned embodiment will be described below with reference to FIG. 9. FIG. 9 shows a configuration of a projection type image displaying apparatus 500 including the semiconductor light source apparatus 106 in the above-mentioned embodiment.

The projection type image displaying apparatus 500 includes an excitation light source 121, a DMD (Digital Mirror Device) 24, and a projection lens 25.

The excitation light source 12l includes the semiconductor light source apparatus 106 described in any one of the above-mentioned embodiments. The excitation light source 12l includes a light emitting element for emitting blue light and outputs blue excitation light.

A condenser lens 6 collects the blue light outputted from the collimator lenses 5. The blue excitation light exiting from the condenser lens 6 enters a lens 7 The lens 7 transforms the entered light into parallel light.

The excitation blue light exiting from the lens 7 passes through a dichroic mirror 8 which allows blue light to pass therethrough and reflects green light, and then enters a condensing/collimating lens 9 including a pair of convex lenses 9a and 9b.

Green light excited by the excitation light and emitted from the green phosphor 102 of the phosphor wheel 101 enters the condensing/collimating lens 9. The green light is collimated by the condensing/collimating lens 9, and exits to the dichroic mirror 8.

The dichroic mirror 8 reflects the green light from the condensing/collimating lens 9, and leads the green light into a dichroic mirror 12 which allows green light to pass therethrough and reflects red light.

A collimating lens 13 includes a pair of convex lenses 13a and 13b. A red light emitting element 14 is disposed to face the collimating lens 13, and emits red light. The red light from the red light emitting element 14 is collimated by the collimating lens 13 and exits to the dichroic mirror 12.

The red light exiting from the collimating lens 13 is reflected by the dichroic mirror 12, subsequently entering a dichroic mirror 15 which allows red light and green light to pass therethrough and reflects blue light.

A collimating lens 16 includes a pair of convex lenses 16a and 16b. A blue light emitting element 17 is disposed to face the collimating lens 16, and emits blue light. The blue from the blue light emitting element 17 is collimated by the collimating lens 16 and exits to the dichroic mirror 15.

In the above-described Tanner, light of three colors, i.e. green light, red light, and blue light, enters a condenser lens 18. Specifically, the green light from the phosphor wheel apparatus 10 is reflected by the dichroic mirror 8 and then passes through the dichroic mirrors 12 and 15, and enters the condenser lens 18. The red light emitted by the red light emitting element 14 is reflected by the dichroic mirror 12 and passes through the dichroic mirror 15, and then enters the condenser lens 18. The blue light emitted by the blue light emitting element 17 is reflected by the dichroic mirror 15, and enters the condenser lens 18.

The condenser lens 18 collects the green light, the red light, and the blue light and leads the collected light to one end face of a rod integrator 19. Outgoing light that exiting from the other end face of the rod integrator 19 passes through relay lenses 20 and 21, and then exits to a total reflection mirror 22.

Light reflected by the total reflection mirror 22 enters the DMD 24 passing through a lens 23. The DMD 24 modulates the entered light according to a video sign and allows the modulated light to exit to the projection lens 25 through the lens 23. The projection lens 25 projects the entered light onto an external screen with enlarged image.

### Other Embodiments

The embodiments 1 to 4 are described above as exemplification of the arts disclosed in the present application. However, the arts of the present disclosure is not limited thereto, and can also be applied to embodiments in which changes, substitutions, additions, omissions, and the like are appropriately made therein. It is also possible to form new embodiments by combining the components described in the above-described embodiments 1 to 4.

In the embodiments 1 to 4, the semiconductor source elements are described as components composing the light source circuits, and specifically, laser diodes and LEDs (light-emitting diodes) can be used as the semiconductor light source elements.

Although a DMD is used as a modulator in the fifth embodiment, the modulator is not limited to the DMD. For example, the modulator may be implemented by a liquid crystal panel.

The semiconductor light source apparatuses according to the first to fourth embodiments can be used as light sources of various apparatuses such as light sources for a projection type image displaying apparatus (projector) and light sources for illumination.

The embodiments are described as examples of the arts in the present disclosure. To this end, the accompanying drawings and the detailed description are provided.

Accordingly, the components described in the accompanying drawings and the detailed description may include not only components necessary for solving the problem, but also components not necessary for solving the problem in order to exemplify the above-described arts. Hence, if those unnecessary components are described in the accompanying drawings and the detailed description, it should not be acknowledged that such fact directly founds that the unnecessary components are necessary.

In addition, since the above-described embodiments are to exemplify the arts of the present disclosure, various changes, substitutions, additions, omissions, and the like may be made therein within the range of the claims or within the range of equivalency of the claims.

### INDUSTRIAL APPLICABILITY

The present disclosure can be applied to a semiconductor light source apparatus which drives a plurality of serially-connected semiconductor light source elements. Specifically, the present disclosure can be applied to light sources for projectors, light sources for illumination, and so on.

What is claimed is:

1. A semiconductor light source apparatus comprising:
a first light source circuit that includes one or more serially-connected semiconductor light source elements;
a second light source circuit that includes one or more serially-connected semiconductor light source elements, the second light source circuit being serially connected to the first light source circuit via a connecting portion on a low-voltage side of the first light source circuit;
a power source circuit configured to supply a power supply voltage to a series connection circuit including the first light source circuit and the second light source circuit; and
a conductor to which the first light source circuit and the second light source circuit are mounted, wherein
the connecting portion is electrically connected and grounded to the conductor.

2. The semiconductor light source apparatus according to claim 1, wherein
the connecting portion includes a resistor for detecting a current serially connected between the first light source circuit and the second light source circuit, and
a connection point between the resistor and the second light source circuit is connected and grounded to the conductor.

3. The semiconductor light source apparatus according to claim 1, wherein
the connecting portion includes a resistor for detecting a current serially connected between the first light source circuit and the second light source circuit, and
a connection point between the resistor and the first light source circuit is connected and grounded to the conductor.

4. The semiconductor light source apparatus according to claim 1, wherein
a resistor for detecting a current is serially connected between the power source circuit and the first light source circuit.

5. The semiconductor light source apparatus according to claim 1, wherein
a resistor for detecting a current is serially connected between the power source circuit and the second light source circuit.

6. The semiconductor light source apparatus according to claim 2, further comprising a current detecting circuit that detects a current flowing through the resistor, wherein
the power source circuit controls the power supply voltage supplied to the first and second light source circuits based on an output of the current detecting circuit.

7. A projection type image displaying apparatus comprising:
the semiconductor light source apparatus according to claim 1;
an optical system configured to transmit light from the semiconductor light source apparatus; and
a modulator configured to modulate the light received through the optical system according to a video signal to output the modulated light.

8. The semiconductor light source apparatus according to claim 3, further comprising a current detecting circuit that detects a current flowing through the resistor, wherein
the power source circuit controls the power supply voltage supplied to the first and second light source circuits based on an output of the current detecting circuit.

9. The semiconductor light source apparatus according to claim 4, further comprising a current detecting circuit that detects a current flowing through the resistor, wherein
the power source circuit controls the power supply voltage supplied to the first and second light source circuits based on an output of the current detecting circuit.

10. The semiconductor light source apparatus according to claim 5, further comprising a current detecting circuit that detects a current flowing through the resistor, wherein
the power source circuit controls the power supply voltage supplied to the first and second light source circuits based on an output of the current detecting circuit.
